(19) United States
(12) Patent Application Publication
(10) Pub. No.: US 2006/0040403 A1
(43) Pub. Date: Feb. 23, 2006

(54) System and method for providing a reaction using a limited reaction surface area

(75) Inventors: Karin L. Bogren, Fort Collins, CO (US); Stephen J. Takacs, Evans, CO (US); James R. Harbridge, Thornton, CO (US)

Correspondence Address: SETTER OLLILA, LLC, 2060 BROADWAY, SUITE 300, BOULDER, CO, 80302, US

(73) Assignee: HACH COMPANY

(21) Appl. No.: 11/053,111

(22) Filed: Feb. 8, 2005

Related U.S. Application Data
(60) Provisional application No. 60/603,073, filed on Aug. 20, 2004.

(51) Int. Cl. B01L 3/00

(52) U.S. Cl. 436/180; 422/100

(57) ABSTRACT

A method and apparatus for chemical analysis is disclosed that uses a sample cup insert. The insert is pre-coated with a reaction agent, enzyme, or chemical to facilitate testing of the sample. A sample fluid in the sample cup is agitated by fluid pulsing to speed the reaction or to speed a pre-conditioning step.

### RELATED APPLICATIONS

This application is related to provisional application number 60/603,073 “A System and Method for Providing a Reaction Using a Limited Reaction Surface Area” filed on Aug. 20, 2004, which is hereby incorporated by reference.

### BACKGROUND OF THE INVENTION

1. Field of the Invention

The invention is related to the field of analyzers, and in particular, to discrete wet chemical analyzers.

2. Statement of the Problem

FIG. 1 shows a bench top discrete analyzer for wet chemistry. In typical discrete analyzers a sample is placed in the analyzer. The analyzer draws a small amount of the sample into a sample probe and transfers it to a reaction well. Each reaction well may contain a cell where the reaction takes place. A cell is typically a small container or cup or flowcell configured to hold the sample and any reagents used in the chemical reaction. The cell may be disposable or may be reusable after reconditioning. Once the sample has been transferred to the cell, the analyzer rinses the sample probe and then draws any reagents needed for the reaction, from the reagent reservoirs, and transfers the reagent to the reaction cell. The analyzer may stir the sample and reagent, using the sample probe, to aid in the reaction. Once sufficient time has passed for the reaction to occur, the analyzer transfers the mixture to a flow cell where it will be moved into the testing area and tested for the results of the reaction. Some reactions require the sample to be pre-conditioned before a reagent is added for a reaction. For example, in the cadmium reduction method, the sample must be exposed to a cadmium source before being combined with the color forming reagents. In the cadmium reduction method, the amount of preconditioning for a given sample size is a function of the surface area of the cadmium source per volume of sample and the time of exposure to the source. In some analyzers, the sample is passed through a long thin tube or coil where the inside of the tube has been coated with cadmium. This tends to maximize the surface area of the cadmium source for the give sample size. In some analyzers, the cadmium source is placed inline with the sample probe. With the inline cadmium source every sample drawn into the sample probe passes through the cadmium source unless a switching valve is installed. The switching valve adds cost and complexity to the instrument. FIG. 2 shows a bench top discrete analyzer for wet chemistry with a cadmium coil mounted inline with the sample and reagent probe.

Putting the cadmium source inline with the sample probe has a number of disadvantages. With the cadmium source inline, every sample transferred through the sample probe passes through the cadmium source. Most discrete analyzers do more than one type of test. If the test does not need the preconditioning step, or can't tolerate being exposed to cadmium, the analyzer may not be able to run the test in the inline configuration. Another problem with the inline cadmium source is that the cadmium source may become contaminated by the transfer of a sample to the reaction well. The cadmium source may also have a limited life. Once the cadmium has been depleted, the source must be reconditioned or replaced before more testing can be performed. In the inline configuration, the analyzer can not be used for any type of testing while the cadmium source is being cleaned or reconditioned.

Therefore there is a need for a system and method for providing a better solution for preconditioning samples.

### SUMMARY OF THE INVENTION

A method and apparatus for chemical analysis is disclosed that uses a sample cup insert. The insert is pre-coated with a reaction agent, enzyme, or chemical to facilitate testing of the sample. A sample fluid in the sample cup is agitated by fluid pulsing to speed the reaction or to speed a pre-conditioning step.

### BRIEF DESCRIPTION OF THE DRAWINGS

FIG. 1 is an isometric view of a prior art discrete bench top analyzer.

FIG. 2 is a isometric view of a prior art discrete bench top analyzer with an inline cadmium coil.

FIG. 3 is an isometric view of a sample cell.

FIG. 4 is a graph of the amount of fluid drawn into a sample probe vs. time in an example embodiment of the invention.

FIG. 5 a top view of a sample cup, in an example embodiment of the invention, showing the different locations along the stirring path where the release of the fluid back into the sample cup begins.

FIG. 6 is a drawing of an insert with a smooth or cylindrical inner surface in an example embodiment of the current invention.

FIG. 7 is an assembly drawing of a smooth inner surface cadmium insert and a sample cup in an example embodiment of the current invention.

FIG. 8 is a flow chart in an example embodiment of the invention.

### DETAILED DESCRIPTION OF THE PREFERRED EMBODIMENT

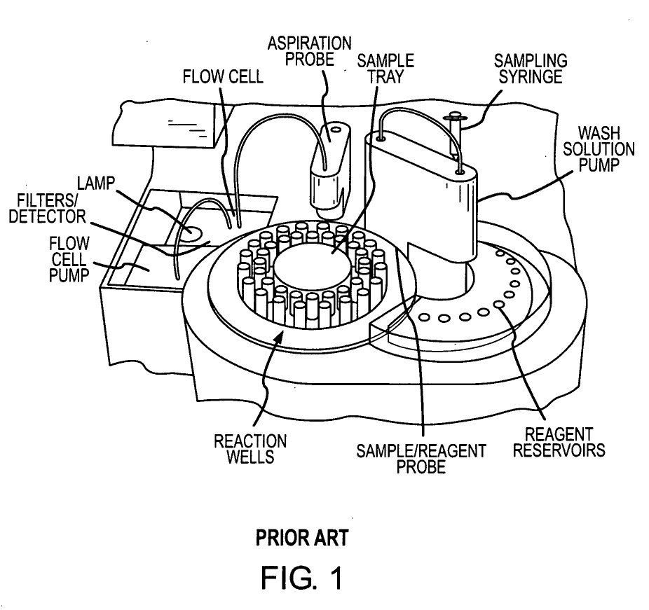

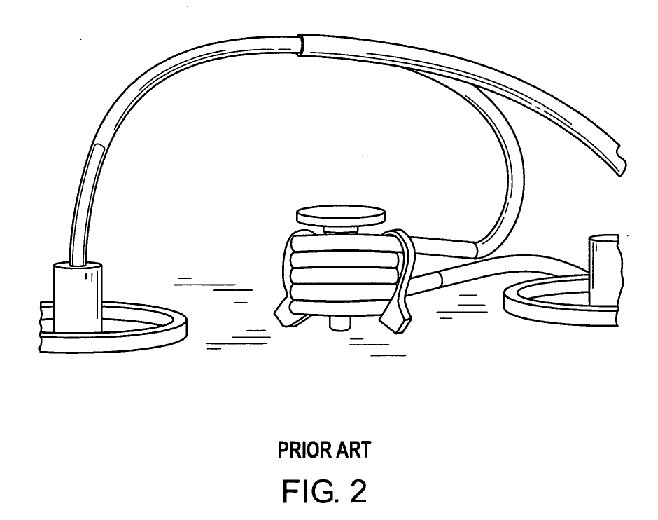

FIGS. 1-8 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

When doing discrete tests in an analyzer, preconditioning the sample using an inline source has a number of disadvantages as discussed above. One way to overcome these disadvantages is to move the preconditioning source into a sample aspiration cup or cell. Unfortunately, the typical cell does not contain enough surface area for the sample volume to provide the proper preconditioning in the time needed using normal agitation methods.

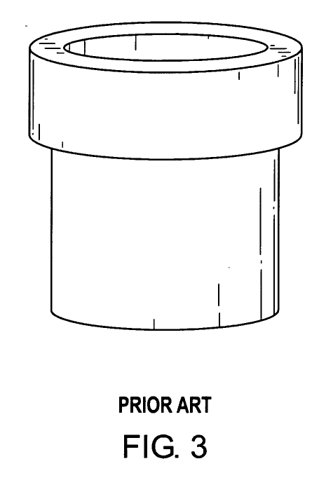

FIG. 3 is an isometric view of a typical sample cell. The discrete analyzer where the cell will be used determines the height and diameter of the sample cell being used. This is typically dependent on the volume of the sample required for testing as well as the amount of the reagents needed for the reaction. The sample probe diameter and the stirring radius determine the minimum inner diameter of the sample cell used in the analyzer.

In one example embodiment of the invention, agitating the sample fluid in the sample cell is performed using two complementary techniques. The first technique is to stir the sample fluid in the sample cell using the sample probe. Stirring the sample fluid, using a circular motion, with the sample probe is well known in the arts. The second technique is to draw or suck a portion of the sample fluid, from the sample cup, back into the sample probe and then squirt or release the portion of the sample fluid from the sample probe back into the sample cup. The action of drawing the fluid from the cell into the sample probe and then squirting the fluid back into the cell can be repeated. For this application, the act of drawing the fluid from the sample cell into the sample probe and then squirting or releasing the fluid back into the sample cell will be called fluid pulsing. Fluid pulsing increase the agitation rate in the sample cup which can shorten the time required for a reaction to occur.

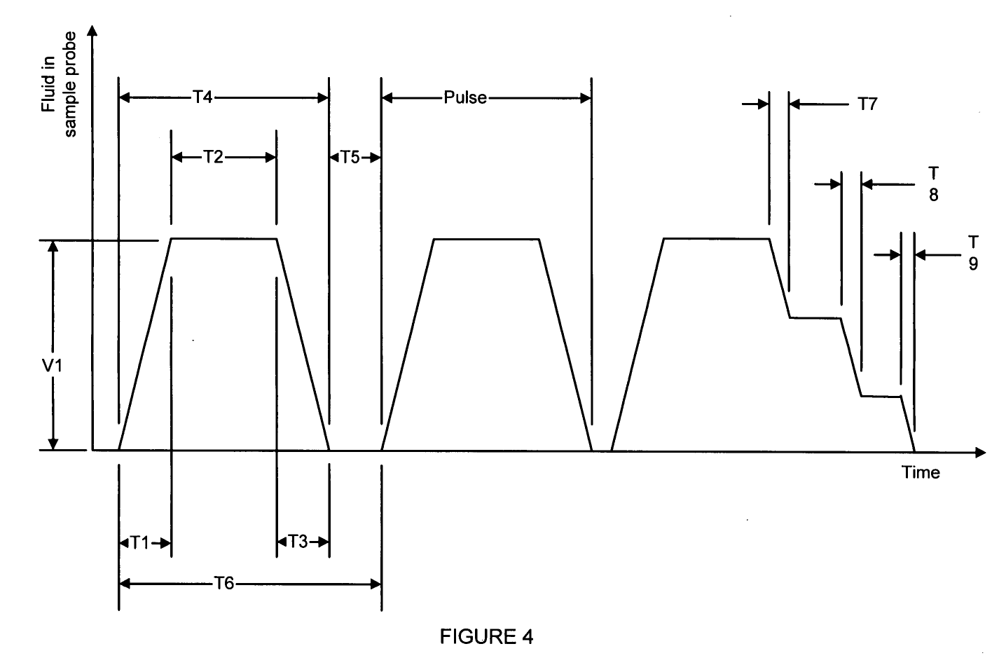

There are a number of variables that can be adjusted in fluid pulsing, for example the amount of fluid drawn back into the sample probe may be varied, the cycle time between fluid pulses may be varied, the rate at which the fluid is sucked up or squirted out of the sample probe may be changed, and the number of time the fluid is drawn into and then released from the sample probe may be changed. FIG. 4 is a graph of the amount of fluid drawn into a sample probe vs. time in an example embodiment of the invention. Time T1 is the time it takes to draw a sample fluid, from a sample cup, into a sample probe. Time Ti is a function of the rate at which the sample fluid is drawn into the sample probe and the total volume (V1) drawn into the sample probe. The time the fluid is retained in the sample probe before being released back into the sample cup, is time T2. In one example embodiment of the invention, time T2 is set to zero to minimize the amount of time the sample fluid is no longer in contact with the sample cup. The time it takes to release or squirt the sample fluid back into the sample cup is time T3. The total pulse time is T4. The time between the end of one pulse and the start of another pulse is T5. The cycle time from the start of one pulse to the start of another pulse is time T6.

In one example embodiment of the invention, the fluid pulsing is repeated with a constant cycle time. In another example embodiment, the fluid pulsing is repeated using a variable cycle time. There are a number of different ways that the cycle time may be varied, for example changing the volume of fluid drawn into the sample probe, changing the time between pulses (T5), changing the time the fluid is retained in the sample probe before being released back into the sample cup (T2), or the like. In one example embodiment of the invention, the fluid drawn into the sample probe may be squirted back into the sample cup in a series of small pulses, for example the pulses that occur at times T7, T8 and T9. In one example embodiment of the invention, the rate the fluid is released back into the sample cup is different than the rate at which the fluid is drawn into the sample probe (not shown), for example the sample fluid is drawn into the sample probe at a high rate over a short time period, and then released back into the sample cup using a slow rate over a longer period of time. In one example embodiment, 300 μL of the sample is drawn from the sample cell into the sample probe for the fluid pulsing.

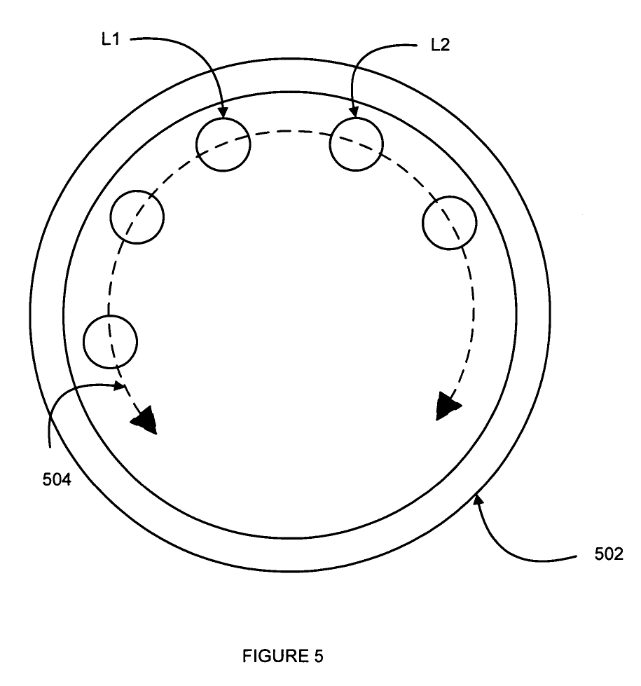

The two agitation methods, stirring and fluid pulsing, may be done one after the other, at the same time, or in some combination. For example, the sample probe may first stir the sample fluid for a preset time and then do fluid pulsing while the sample probe continues stirring. In another example embodiment, the stirring and fluid pulsing may start at the same time. In one example embodiment of the invention, the sample fluid is stirred and fluid pulsed for approximately 5 seconds after the sample fluid is placed into the sample cup. The sample fluid is then left in the sample cup for approximately 15 minutes. The sample fluid is then stirred a second time for approximately 5 seconds. The sample fluid is then transferred to a reaction cuvette to continue the testing process. When the stirring and fluid pulsing occur simultaneously, the frequency or cycle time of the fluid pulsing may be adjusted such that the release of the sample fluid back into the sample cup, occurs at different locations in the sample cup. FIG. 5 is a top view of a sample cup 502 showing the different locations along stirring path 504 where the release of the fluid back into the sample cup begins. For the first pulse, the fluid is squirted out at location L1, the second pulse beings at location L2, etc.

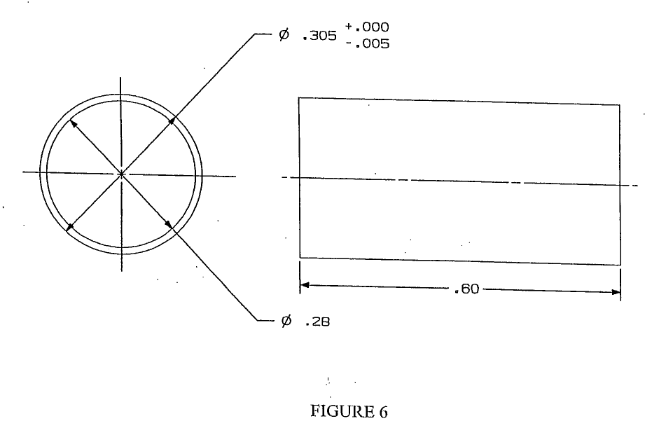

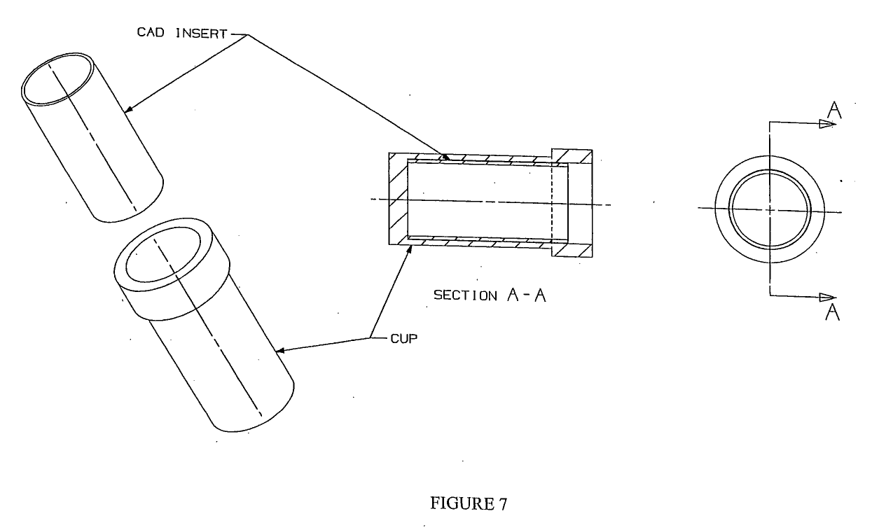

In one example embodiment of the current invention, cadmium is used as the active surface for a reaction. The amount of cadmium present in the reaction cell or sample cell is a function of the surface area of the sample cell and the thickness of the coating. A sample cell or insert having a corrugated or ribbed inner surface coated with cadmium will have more cadmium than a cell or insert having a smooth or cylindrical inner surface. The total amount of cadmium in the sample cell is important for a number of reasons. One reason is that a cell can be disposable if the total amount of cadmium is below a threshold amount. If the total amount of cadmium is above the threshold amount, the cell must be recycled or treated as containing hazardous material. Using a cell or insert with the smooth inner surface may allow the total amount of cadmium present in the cell to fall below the threshold amount that allows the cell to be disposable. FIG. 6 is a drawing of an insert with a smooth or cylindrical inner surface. Using the agitation techniques with a sample cell having a smooth inner wall may shorten the time required for a given reaction. FIG. 7 is an assembly drawing of a sample cell using an insert with a smooth inner surface. This invention is not limited to use with sample cups having a smooth or cylindrical inner surface. Using the agitation techniques with a cell or insert having a corrugated or ribbed inner surface may shorten the required time for a pre-conditioning step or for a reaction.

In another example embodiment of the invention, the amount that the sample probe is inserted into the sample fluid, may be varied during fluid pulsing or during stirring, or during the combination of stirring and fluid pulsing. In another example embodiment of the invention, the direction that the sample probe travels while stirring, may be change, for example from a clockwise motion to a counter clockwise motion. Other stirring paths are also possible, for example a figure eight motion. In one example embodiment of the invention, when the active material for a reaction is on an insert with no bottom, the sample probe may be positioned in the center of the sample cup as the sample fluid is drawn into the sample probe. And then the sample probe may be positioned near the inner surface of the insert as the fluid is released from the sample probe back into the sample cup. In another example embodiment of the invention, when a sample cup with an active surface on the bottom of the cup is used in the reaction, the sample probe may be positioned in the center of the sample cup as the sample fluid is drawn into the sample probe. And then the sample probe may be positioned near the bottom of the cup as the fluid is released from the sample probe back into the sample cup. Other intake and outlet positions for the sample probe are possible and may be a function of the sample cup geometry, the sample probe size and shape, the speed at which the sample fluid can be drawn in and squirted out of the sample probe, the reaction type, and the like.

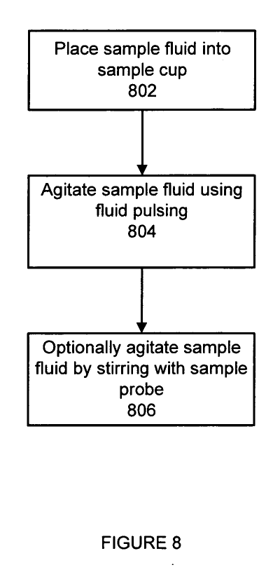

FIG. 8 is a flow chart of a method in an example embodiment of the current invention. At step 802 a sample fluid is placed into a sample cup. At step 804 the sample fluid is agitated in the sample cup by using fluid pulsing. At step 806 the sample fluid is optionally agitated by stirring the sample fluid with a sample probe.

Some of the active materials used in the reactions may be toxic. In one example embodiment of the invention, the cell would be configured with a cap or lid to seal the active material, contained on the cell interior or on the insert, to prevent exposure to the environment.

We claim:

1. A method, comprising:
dispensing a fluid into a sample cup using a sample probe;
agitating the fluid in the sample cup by using fluid pulsing.

2. The method of claim 1 where the sample cup is a reaction cup.

3. The method of claim 1 further comprising:
repeating, at least once, the fluid pulsing after a preset time has elapsed.

4. The method of claim 3 where the preset time is zero.

5. The method of claim 3 further comprising:
varying a pulse length of the fluid pulsing where the pulse length is defined as the time between the start of drawing the fluid into the sample probe and ending when the last of the re-drawn fluid is re-dispensed back into the sample cup.

6. The method of claim 5 where the pulse length is varied by changing an amount of the fluid drawn back into the sample probe during the fluid pulse.

7. The method of claim 3 further comprising:
varying a cycle time between fluid pulsing where the cycle time is defined as the time between the start of one fluid pulse and the start of a next fluid pulse.

8. The method of claim 1 further comprising:
agitating the fluid in the sample cup by stirring the fluid with the sample probe.

9. The method of claim 8 where the fluid pulsing and the stirring occur simultaneously.

10. The method of claim 1 where fluid pulsing comprises drawing a first amount of the fluid back into the sample probe from the sample cup and then re-dispensing the first amount of fluid from the sample probe back into the sample cup.

11. The method of claim 10 where a first rate is used to draw the fluid back into the sample probe and a second rate is used to re-dispense the fluid back into the sample cup.

12. The method of claim 11 where the first rate is equal to the second rate.

13. The method of claim 10 where the amount of the fluid drawn into the sample probe is approximately 300 micro-liters.

14. The method of claim 10 where re-dispensing the fluid back into the sample cup comprises:
(a) re-dispensing a second amount of the fluid back into the sample cup where the second amount is less than the first amount;
(b) waiting a predetermined time and then re-dispensing a third amount of the fluid back into the sample cup where the third amount is less than the first amount.

15. The method of claim 14 where the second amount is the same as the third amount.

16. The method of claim 14 further comprising:
repeating step (b).

17. The method of claim 10 further comprising:
positioning the sample probe at a first position at the start of when the fluid is drawn into the sample probe;
positioning the sample probe at a second location at the start of when the fluid is re-dispensed back into the sample cup.

18. The method of claim 17 where a difference between the first position and the second position is along a circle centered on a cylindrical axis of the sample cup.

19. The method of claim 17 where a difference between the first position and the second position is along a radius extending from a cylindrical axis of the sample cup.

20. The method of claim 17 where a difference between the first position and the second position is in the depth the sample probe has been inserted into the sample cup.

21. A discrete analyzer, comprising:
a controller configured to direct a sample probe such that a fluid is dispensed into a reaction cup;
the controller configured to agitate the fluid in the reaction cup by:
(a) drawing a portion of the fluid back into the sample probe;
(b) and then forcing the portion of the fluid in the sample probe back into the reaction cup after a preset time.

22. The discrete analyzer of claim 21 where the preset time is zero.

23. The discrete analyzer of claim 21 further comprising:
varying a pulse length of the fluid pulsing where the pulse length is defined as the time between the start of drawing the fluid into the sample probe and ending when the last of the re-drawn fluid is forced back into the sample cup.

24. The discrete analyzer of claim 23 where the pulse length is varied by changing an amount of the fluid drawn back into the sample probe during the fluid pulse.

25. The discrete analyzer of claim 21 where the controller is configured to agitate the fluid in the sample cup by stirring the fluid with the sample probe.

26. The discrete analyzer of claim 25 where the fluid pulsing and the stirring occur simultaneously.

27. The discrete analyzer of claim 21 where a first rate is used to draw the fluid back into the sample probe and a second rate is used to force the fluid back into the reaction cup.

28. The discrete analyzer of claim 27 where the first rate is equal to the second rate.

29. The discrete analyzer of claim 21 where the amount of the fluid drawn into the sample probe is approximately 300 micro-liters.

30. The discrete analyzer of claim 21 where forcing the fluid back into the sample cup comprises:
(a) re-dispensing a second amount of the fluid back into the reaction cup where the second amount is less than the first amount;
(b) waiting a predetermined time and then re-dispensing a third amount of the fluid back into the reaction cup where the third amount is less than the first amount.

31. The discrete analyzer of claim 30 where the second amount is the same as the third amount.

32. The discrete analyzer of claim 30 further comprising:
repeating step (b).

33. The discrete analyzer of claim 21 where the controller is configured to position the sample probe at a first position at the start of when the fluid is drawn into the sample probe; and
where the controller is configured to position the sample probe at a second location at the start of when the fluid is forced back into the reaction cup.

34. The discrete analyzer of claim 33 where a difference between the first position and the second position is along an arch centered on a cylindrical axis of the sample cup.

35. The discrete analyzer of claim 33 where a difference between the first position and the second position is along a radius extending from a cylindrical axis of the sample cup.

36. The discrete analyzer of claim 33 where a difference between the first position and the second position is in the depth the sample probe has been inserted into the sample cup.

37. A computer program, when executed on a processor in a discrete analyzer, configured to cause the discrete analyzer to:
dispense a fluid into a sample cup using a sample probe;
agitate the fluid in the sample cup by using fluid pulsing.

38. A discrete analyzer, comprising:
means for holding a fluid to be tested;
means for dispensing the fluid to be tested into the holding means;
means for agitating the fluid to be tested in the holding means by using fluid pulsing.
